(19) United States
(12) Patent Application Publication
(10) Pub. No.: US 2023/0260149 A1
(43) Pub. Date: Aug. 17, 2023

(54) POSITION-POSTURE ESTIMATION DEVICE, POSITION-POSTURE ESTIMATION METHOD, AND STORAGE MEDIUM STORING PROGRAM

(71) Applicant: Mitsubishi Electric Corporation, Tokyo (JP)

(72) Inventor: Ken MIYAMOTO, Tokyo (JP)

(73) Assignee: Mitsubishi Electric Corporation, Tokyo (JP)

(21) Appl. No.: 18/138,300

(22) Filed: Apr. 24, 2023

Related U.S. Application Data
(63) Continuation of application No. PCT/JP2020/047417, filed on Dec. 18, 2020.

(51) Int. Cl. G06T 7/70; G06T 17/05; G06T 7/30; G06T 7/80; G06V 10/74

(52) U.S. Cl. CPC G06T 7/70; G06T 17/05; G06T 7/30; G06T 7/80; G06V 10/761; G06T 2207/30244

(57) ABSTRACT

A position-posture estimation device includes processing circuitry to read in data of a three-dimensional map from a database; to execute a process of selecting a frame to be used for calculation of a position-posture from a plurality of image frames captured from different viewpoints; to execute a process of acquiring a plurality of relative position-postures regarding a plurality of frames selected by the frame selection unit; to execute a process of acquiring a plurality of absolute position-postures regarding the plurality of selected frames; and to acquire a final absolute position-posture by integrating the acquired relative position-postures and the acquired absolute position-postures.

### CROSS-REFERENCE TO RELATED APPLICATION

This application is a continuation application of International Application No. PCT/JP2020/047417 having an international filing date of Dec. 18, 2020.

### BACKGROUND OF THE INVENTION

### 1. Field of the Invention

The present disclosure relates to a position-posture estimation device, a position-posture estimation method and a program.

### 2. Description of the Related Art

In regard to devices employing augmented reality (AR), robots employing automated guided vehicle (AGV), and the like, there has been proposed a method for increasing the accuracy of calculation (i.e., estimation) of a position-posture by combining a result of calculation of the relative position-posture with a result of calculation of an absolute position-posture. See Patent Reference 1, for example.

The calculation of the relative position-posture is calculation of a relative movement amount from a certain position-posture, and is a process repeatedly executed at a constant cycle (in general, a short cycle). For example, simultaneous localization and mapping (SLAM) in which the movement amount is obtained based on a camera image as an image captured by a camera or a distance detected by a distance sensor, a method using an inertial measurement unit (IMU) including a gyro sensor, an acceleration sensor or the like integrated therewith, autonomous navigation in which the movement amount is obtained based on revolution speed of a wheel, or the like is used for the calculation of the relative position-posture. In these methods, an error develops upon each calculation of the relative position-posture, and thus there is a problem in that the accumulated error becomes significant in a long-distance movement. Therefore, a process of periodically removing the error accumulated due to the calculations of the relative position-posture is executed by combining the result of the calculation of the relative position-posture with the result of the calculation of the absolute position-posture.

The calculation of the absolute position-posture is executed by using a previously prepared three-dimensional map, and is executed in front of an object indicated by the three-dimensional map, for example. The calculation of the absolute position-posture is executed by using the three-dimensional map and a camera image, for example.

FIG. 1 is a diagram showing an example in which a terminal 111 employing AR estimates the position-posture by using the calculation of the relative position-posture and the calculation of the absolute position-posture when a user 112 carrying the terminal 111 has moved. The terminal 111 is a tablet terminal, a terminal employing a head mounted display (HMD), or the like, for example. In this case, the terminal 111 moves while executing relative position-posture calculation (1), removes accumulated error by using a result of absolute position-posture calculation (2) executed in front of an object 113 indicated by the three-dimensional map, and thereafter moves while executing relative position-posture calculation (3). By this method, the position-posture can be estimated with high accuracy even when the terminal 111 is apart from the object 113 indicated by the three-dimensional map, and consequently, it is possible to keep on displaying AR content, in superimposition on a real image displayed on the terminal's screen, at an appropriate position in the real image.

FIG. 2 is a diagram showing an example in which a robot 121 employing AGV estimates the position-posture by using the calculation of the relative position-posture and the calculation of the absolute position-posture when the robot 121 has moved. In this case, the robot 121 moves while executing relative position-posture calculation (4), removes accumulated error by using a result of absolute position-posture calculation (5) executed in front of an object 123 indicated by the three-dimensional map, and thereafter moves while executing relative position-posture calculation (6). By this method, the robot 121 is capable of estimating its own position-posture with high accuracy even when the robot 121 is apart from the object 123 indicated by the three-dimensional map, and consequently, the robot 121 is capable of correctly arriving at a targeted position.
Patent Reference 1: Japanese Patent Application Publication No. 2019-160147.

However, the conventional estimation of the absolute position-posture is executed by using only one frame (i.e., one image frame), and thus there is a problem in that the accuracy of the calculation (i.e., the accuracy of the estimation) varies greatly depending on the subject included in one frame.

For example, in the case of using a camera image, the accuracy of the calculation of the absolute position-posture can vary depending on a pattern on the subject. Specifically, the calculation of the absolute position-posture can be executed with high accuracy when the pattern on the subject is characteristic, whereas the accuracy of the calculation of the absolute position-posture decreases when the pattern on the subject is an iterative pattern such as stripes or horizontal stripes or when the subject is an object with no pattern such as a pure white wall.

Further, in cases where the absolute position-posture is calculated by using distance information regarding the distance to the subject obtained by using a laser beam, infrared rays or the like, the accuracy of the calculation of the absolute position-posture varies greatly depending on the shape of the subject. Specifically, the calculation of the absolute position-posture can be executed with high accuracy when the shape of the subject is characteristic, whereas the accuracy of the calculation of the absolute position-posture decreases when the shape of the subject is not characteristic.

An object of the present disclosure, which has been made to resolve the above-described problems, is to provide a position-posture estimation device, a position-posture estimation method and a program capable of increasing the accuracy of the estimation of the position-posture.

### SUMMARY OF THE INVENTION

A position-posture estimation device in the present disclosure includes processing circuitry to read in data of a three-dimensional map from a database; to execute a process of selecting a frame to be used for calculation of a position-posture from a plurality of image frames captured from different viewpoints; to execute a process of acquiring a plurality of relative position-postures regarding a plurality of frames selected by the frame selection unit; to execute a process of acquiring a plurality of absolute position-postures regarding the plurality of selected frames; and to acquire a final absolute position-posture by integrating the acquired relative position-postures and the acquired absolute position-postures.

A position-posture estimation method in the present disclosure is a method executed by a position-posture estimation device, the method including reading in data of a three-dimensional map from a position database, executing a process of selecting a frame to be used for calculation of a position-posture from a plurality of image frames captured from different viewpoints, executing a process of acquiring a plurality of relative position-postures regarding a plurality of selected frames, executing a process of acquiring a plurality of absolute position-postures regarding the plurality of selected frames, and acquiring a final absolute position-posture by integrating the acquired relative position-postures and the acquired absolute position-postures.

According to the device, method or program in the present disclosure, the accuracy of the estimation of the position-posture can be increased.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a diagram showing an example in which a terminal employing AR estimates a position-posture by using calculation of a relative position-posture and calculation of an absolute position-posture when a user carrying the terminal has moved;

FIG. 2 is a diagram showing an example in which a robot employing AGV estimates a position-posture by using calculation of a relative position-posture and calculation of an absolute position-posture when the robot has moved;

FIG. 3 is a diagram showing an example of a hardware configuration of a position-posture estimation device according to a first embodiment and a position-posture estimation system including the position-posture estimation device;

FIG. 4 is a diagram showing an example of a hardware configuration of the position-posture estimation device shown in FIG. 3;

FIG. 5 is a functional block diagram schematically showing a configuration of a three-dimensional map generation device according to the first embodiment;

FIG. 6 is a diagram showing an example of a process of adding a random pattern to an image;

FIG. 7 is a diagram showing a process of positioning and registering a three-dimensional map in register with a floor map;

FIG. 8 is a functional block diagram schematically showing a configuration of the position-posture estimation device according to the first embodiment;

FIG. 9 is a flowchart showing an example of a process for generating a three-dimensional map executed by the three-dimensional map generation device according to the first embodiment;

FIG. 10 is a flowchart showing an example of a process for estimating a position-posture executed by the position-posture estimation device according to the first embodiment;

FIG. 11 is a flowchart showing another example of the process for estimating the position-posture executed by the position-posture estimation device according to the first embodiment;

FIG. 12 is a functional block diagram schematically showing a configuration of a three-dimensional map generation device according to a second embodiment;

FIG. 13 is a diagram showing a method of calculating variance used by the three-dimensional map generation device according to the second embodiment;

FIG. 14 is a functional block diagram schematically showing a configuration of a position-posture estimation device according to the second embodiment;

FIG. 15 is a flowchart showing an example of a process for generating a three-dimensional map executed by the three-dimensional map generation device according to the second embodiment;

FIG. 16 is a flowchart showing an example of a process for estimating a position-posture executed by the position-posture estimation device according to the second embodiment;

FIG. 17 is a functional block diagram schematically showing a configuration of a position-posture estimation device according to a third embodiment;

FIG. 18 is a flowchart showing an example of a process for estimating a position-posture executed by the position-posture estimation device according to the third embodiment;

FIG. 19 is a functional block diagram schematically showing a configuration of a position-posture estimation device according to a fourth embodiment; and

FIG. 20 is a flowchart showing another example of the process for estimating a position-posture executed by the position-posture estimation device according to the fourth embodiment.

### DETAILED DESCRIPTION OF THE INVENTION

A position-posture estimation device, a position-posture estimation method and a program according to each embodiment will be described below with reference to the drawings. The following embodiments are just examples and it is possible to appropriately combine embodiments and appropriately modify each embodiment. Further, a “position-posture” in the present application means a position and posture. The “position” means, for example, the position of a terminal or robot equipped with a camera. The “posture” means, for example, a direction of image capturing by the camera or a direction of measurement by a distance sensor.

### (1) FIRST EMBODIMENT

### (1-1) Configuration

### (1-1-1) General Outline

In a first embodiment, a description will be given of improvement in the accuracy of the calculation of the absolute position-posture by using camera images (i.e., captured images) as images captured by the camera. As a method for estimating the position-posture by using a camera image, there has been known a first estimation method. See Non-patent Reference 1, for example.
Non-patent Reference 1: Paul-Edouard Sarlin and three others, “From Coarse to Fine: Robust Hierarchical Localization at Large Scale”, 2019 IEEE/CVF Conference on Computer Vision and Pattern Recognition

In the first estimation method, direct matching is used. In the first estimation method, the position-posture of the camera is directly calculated based on a set of local features of the image.

Further, as a method for estimating the position-posture by using a camera image, there has been known a second estimation method. In the second estimation method, the position-posture of the camera is estimated from the image by using a convolutional neural network (CNN). See Non-patent Reference 2, for example.
Non-patent Reference 2: Samarth Brahmbhatt and four others, “Geometry-Aware Learning of Maps for Camera Localization”, 2018 IEEE/CVF Conference on Computer Vision and Pattern Recognition

In the second estimation method, two-stage matching is used. In the second estimation method, a plurality of images differing in the viewpoint are prepared, an image that is the most similar to the camera image obtained by the image capturing is identified first as a similar image out of the plurality of images, and subsequently the position-posture of the camera is obtained based on correspondence relationship between local features extracted from the similar image and local features extracted from the camera image. In the first embodiment, a method based on the second estimation method is used.

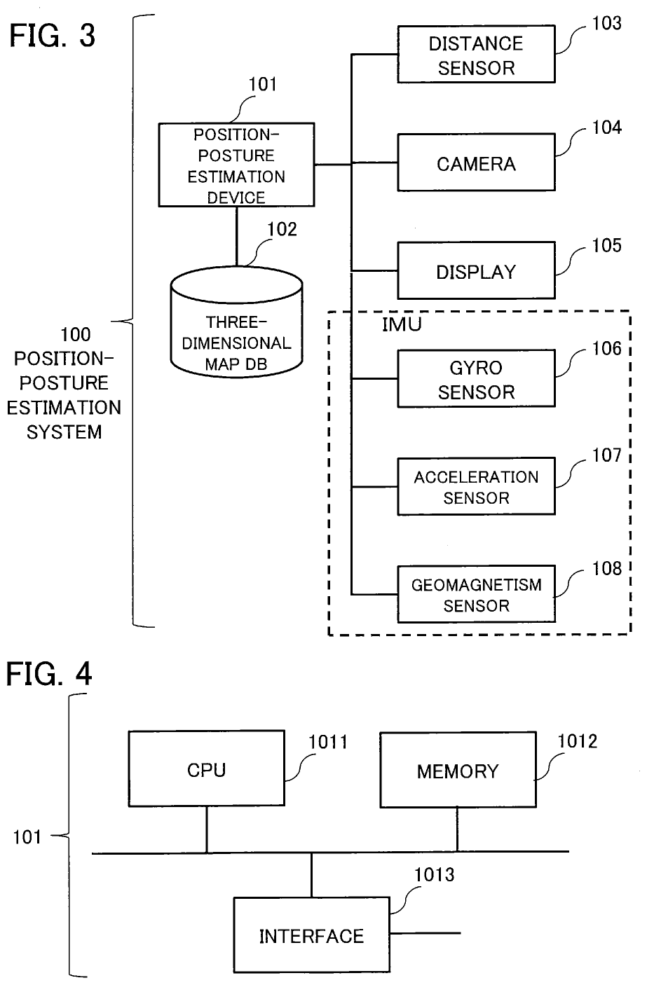

FIG. 3 is a diagram showing an example of a hardware configuration of a position-posture estimation device 101 according to the first embodiment and a position-posture estimation system 100 including the position-posture estimation device 101. The position-posture estimation device 101 according to the first embodiment includes a computer as a calculator that executes calculation for the estimation of the position-posture. In the example of FIG. 3, the position-posture estimation system 100 according to the first embodiment includes the position-posture estimation device 101, a three-dimensional map database (three-dimensional map DB) 102 stored in a storage device, a distance sensor 103, a camera 104 as an image capturing device, and a display 105 such as a liquid crystal display device. Further, in the example of FIG. 3, the position-posture estimation system 100 includes a gyro sensor 106, an acceleration sensor 107 and a geomagnetism sensor 108. A device including the gyro sensor 106, the acceleration sensor 107 and the geomagnetism sensor 108 is referred to also as an “IMU”. The position-posture estimation device 101 and the other components shown in FIG. 3 are connected by a network, for example. The three-dimensional map DB 102 may also be a part of the position-posture estimation device 101.

The three-dimensional map DB 102 includes previously prepared three-dimensional map information to be used when the absolute position-posture is calculated. The three-dimensional map DB 102 does not need to be a part of the position-posture estimation system 100 according to the first embodiment but can also be information stored in an external storage device. Further, the three-dimensional map DB 102 may be generated by the position-posture estimation device 101. In this case, the position-posture estimation device 101 has a function as a three-dimensional map generation device. Namely, the three-dimensional map generation device according to the first embodiment is a part of the position-posture estimation device 101. However, the three-dimensional map generation device according to the first embodiment can also be a device separate from the position-posture estimation device 101.

The distance sensor 103 is an instrument that measures distance by using infrared rays, a laser beam or the like. The camera 104 is an instrument that obtains camera images. The position-posture estimation system 100 may also be configured to include only one of the camera 104 and the distance sensor 103.

The display 105 is a display instrument that is necessary when an AR content is displayed in superimposition on a camera image. The position-posture estimation system 100 may also be configured to include no display 105.

The gyro sensor 106, the acceleration sensor 107 and the geomagnetism sensor 108 constitute the IMU as an instrument for calculating the relative position-posture by means of autonomous navigation. However, in cases where the calculation of the relative position-posture by means of autonomous navigation is not executed, the position-posture estimation system 100 may also be configured without the IMU. Further, the position-posture estimation system 100 may also be configured to include only one or two of the gyro sensor 106, the acceleration sensor 107 and the geomagnetism sensor 108. Incidentally, the instruments connected to the position-posture estimation device 101 can also be part of the instruments shown in FIG. 3 or include a different instrument not shown in FIG. 3.

FIG. 4 is a diagram showing an example of a hardware configuration of the position-posture estimation device 101. The position-posture estimation device 101 includes a CPU (Central Processing Unit) 1011 as an information processing unit, a memory 1012 as a storage device, and an interface 1013. The three-dimensional map DB 102, the distance sensor 103, the camera 104, the display 105, the gyro sensor 106, the acceleration sensor 107 and the geomagnetism sensor 108 are connected to the CPU 1011 via the interface 1013 and a data bus.

Functions of the position-posture estimation device 101 are implemented by processing circuitry. The processing circuitry can be either dedicated hardware or the CPU 1011 executing a program (e.g., a position-posture estimation program) as software stored in the memory 1012 as a storage device. The storage device may be a non-transitory computer-readable storage medium storing a program such as the position-posture estimation program. The CPU 1011 can be any one of a processing device, an arithmetic device, a microprocessor, a microcomputer, a processor and a DSP (Digital Signal Processor).

In the case where the processing circuitry is dedicated hardware, the processing circuitry is, for example, a single circuit, a combined circuit, a programmed processor, a parallelly programmed processor, an ASIC (Application Specific Integrated Circuit), an FPGA (Field-Programmable Gate Array) or a combination of some of these circuits.

In the case where the processing circuitry is the CPU 1011, the functions of the position-posture estimation device 101 are implemented by software, firmware or a combination of software and firmware. The software or firmware is described as a program and stored in the memory 1012. The processing circuitry implements the function of each part by reading out and executing the program stored in the memory 1012. Namely, the position-posture estimation device 101 executes a position-posture estimation method according to the first embodiment when a process is executed by the processing circuitry.

Here, the memory 1012 is, for example, any one of a nonvolatile or volatile semiconductor memory such as a RAM (Random Access Memory), a ROM (Read Only Memory), a flash memory, an EPROM (Erasable Programmable Read Only Memory) or an EEPROM (Electrically Erasable Programmable Read Only Memory), a magnetic disk, an optical disc, a compact disc, a DVD (Digital Versatile Disc), etc.

Incidentally, it is also possible to implement part of the position-posture estimation device 101 by dedicated hardware and part of the position-posture estimation device 101 by software or firmware. As above, the processing circuitry is capable of implementing the functions by hardware, software, firmware or a combination of some of these means.

### (1-1-2) Three-Dimensional Map Generation Device

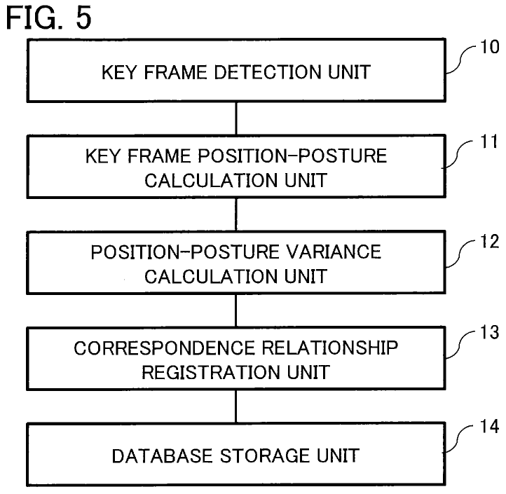

FIG. 5 is a functional block diagram schematically showing the configuration of the three-dimensional map generation device according to the first embodiment. The three-dimensional map generation device shown in FIG. 5 is a device capable of executing a three-dimensional map generation method according to the first embodiment. Incidentally, the following description will be given of an example in which the three-dimensional map generation device is a part (i.e., map generation registration unit) of the position-posture estimation device 101. However, the three-dimensional map generation device can also be a device separate from the position-posture estimation device 101. In this case, the hardware configuration of the three-dimensional map generation device is similar to that shown in FIG. 4.

As shown in FIG. 5, the three-dimensional map generation device according to the first embodiment includes a key frame detection unit 10, a key frame position-posture calculation unit 11, a position-posture variance calculation unit 12, a correspondence relationship registration unit 13 and a database storage unit (DB storage unit) 14. These components construct a three-dimensional map by using a camera image captured by the camera 104 (FIG. 3), distance information obtained by the distance sensor 103 (FIG. 3) and sensor values obtained by the IMU (FIG. 3). Minimum necessary data in the first embodiment is a camera image. The three-dimensional map can be generated even in cases where the distance information or the IMU is not provided.

The key frame detection unit 10 executes a process of detecting an image (e.g., color image) and distance information obtained and detected when the position of the camera 104 moved more than or equal to a previously set threshold value of a translation distance or when the posture of the camera 104 moved (i.e., rotated) more than or equal to a previously set threshold value of a rotation amount as a key frame.

The key frame position-posture calculation unit 11 executes a process of calculating a position-posture of the distance sensor 103 or the camera 104 that captured the key frame detected by the key frame detection unit 10 by a relative position-posture calculation method using an image such as SLAM. The key frame detection unit 10 and the key frame position-posture calculation unit 11 execute a process similar to a process in the conventional SLAM technology (e.g., a process described in Non-patent Reference 3).
Non-patent Reference 3: Raul Mur-Artal and another, “ORB-SLAM2: An Open-Source SLAM System for Monocular, Stereo, and RGB-D Cameras”, IEEE Transactions on Robotics, Vol. 33, No. 5, October 2017.

The position-posture variance calculation unit 12 executes a process of obtaining variance of the position-posture in regard to each of the key frames detected by the key frame detection unit 10. As the method for calculating of the variance of the position-posture, there are a first calculation method and a second calculation method described below, for example.

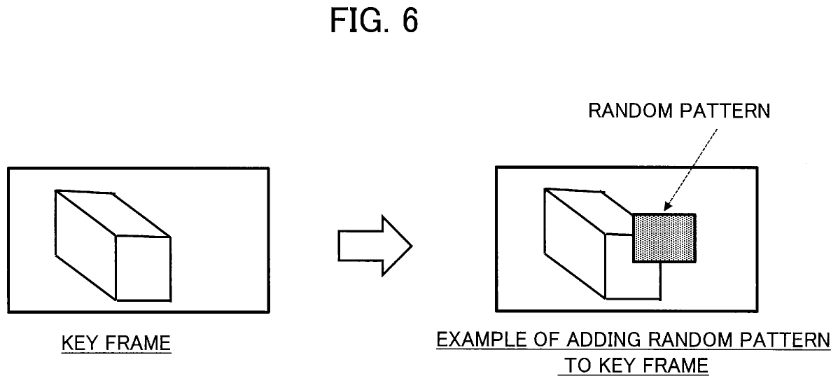

The first calculation method is a method of adding noise (i.e., random pattern) to an image. FIG. 6 is a diagram showing an example of the method of adding noise to an image of a key frame. In the first calculation method, a process of adding a random pattern to the image of the key frame and calculating the position-posture is executed a plurality of times, and the variance of the position-posture is obtained based on a plurality of position-posture calculation results obtained.

The second calculation method is a method using random numbers. In the second calculation method, random sample consensus (RANSAC) is used for the purpose of excluding outliers in a process of calculating the absolute position-posture, for example. The main purpose of RANSAC is to exclude outlier data, as data deviated from data to be used for the calculation of the absolute position-posture, from the observed data. However, in RANSAC, a sample as the target of the calculation is selected randomly and the calculation result takes on a different value each time, and thus RANSAC is usable for the calculation of the variance of the position-posture.

Values σₜ_{ₖ}² and σ_{R}_{ₖ}² respectively represent the variance (σₜₖ²) of the position and the variance (σ_{Rk}²) of the posture, and are respectively calculated according to expression (1) and expression (2). In the expression (1) and the expression (2), N is a positive integer and represents the number of trials used when obtaining the variance. Further, k represents a positive integer.

Values tₙ and Rₙ respectively represent an absolute position (tₙ) and absolute posture (Rₙ) obtained in the n-th trial. Incidentally, n is an integer greater than or equal to 1 and less than or equal to N.

Values μₜ and μ_{R} respectively represent the average (μₜ) of the position and the average (μ_{R}) of the posture, and are respectively calculated according to expression (3) and expression (4).

$${σ}_{{t}_{k}}^{2} = \frac{1}{N} {\sum }_{n = 1}^{N} {( {t}_{n} - {μ}_{t} )}^{2} \qquad ( 1 )$$

$${σ}_{{R}_{k}}^{2} = \frac{1}{N} {\sum }_{n = 1}^{N} {( {R}_{n} - {μ}_{R} )}^{2} \qquad ( 2 )$$

$${μ}_{t} = \frac{1}{N} {\sum }_{n = 1}^{N} {t}_{n} \qquad ( 3 )$$

$${μ}_{R} = \frac{1}{N} {\sum }_{n = 1}^{N} {R}_{n} \qquad ( 4 )$$

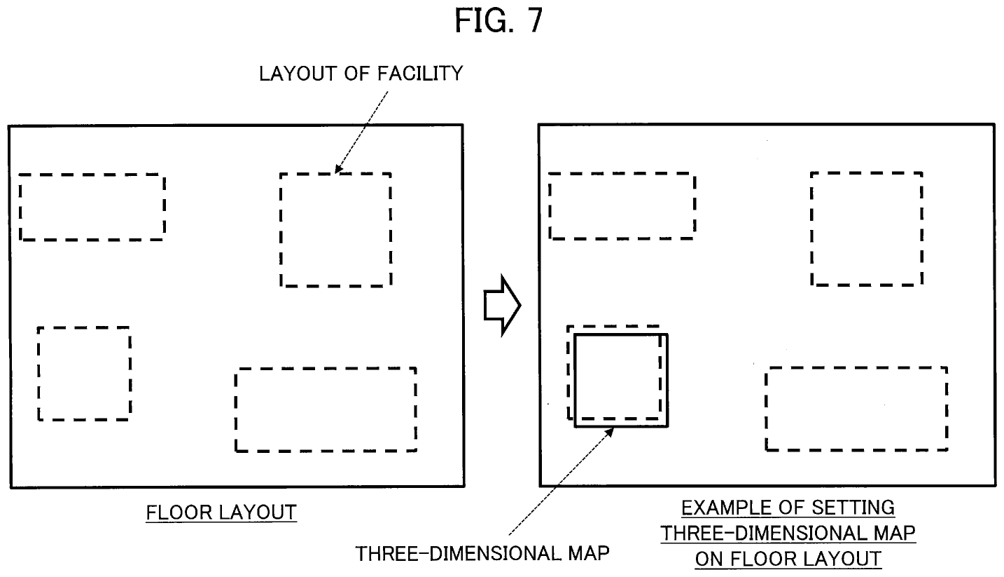

FIG. 7 is a diagram showing a process of positioning and registering the three-dimensional map in register with a floor map. The floor map in FIG. 7 is a floor layout on which a layout indicating the arrangement of facilities is drawn. On the floor map, an installation region as a region where a facility should be arranged is indicated by a broken line rectangle. The correspondence relationship registration unit 13 executes a process of defining relationship with another three-dimensional map or an overall map. When a three-dimensional map (indicated by a solid line rectangle) is registered on the layout of the floor map as shown in FIG. 7, positional relationship between three-dimensional maps and correspondence relationship between a three-dimensional map being generated and an already-constructed three-dimensional map are obtained. By positioning and registering a three-dimensional map in register with the floor map, consistency between the overall map and the three-dimensional map or positional relationship between a plurality of three-dimensional maps is defined.

The database storage unit 14 stores the three-dimensional map generated by the above-described method (i.e., data in regard to each key frame obtained by SLAM, for example) in the three-dimensional map DB 102 (FIG. 3). The three-dimensional map DB 102 stores the position-posture, the camera image, the distance information (i.e., distance image) and a local feature point set obtained for each key frame, for the number of key frames.

### (1-1-3) Position-Posture Estimation Device

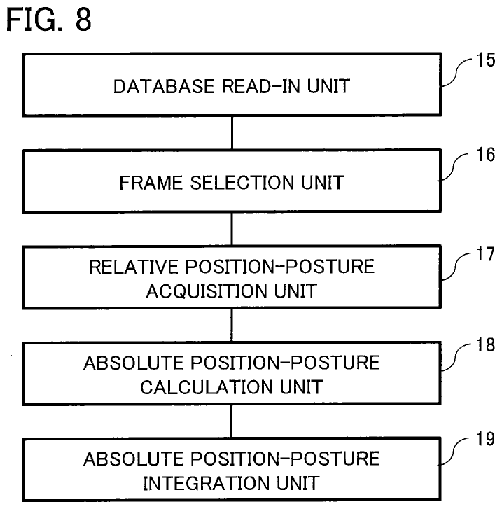

FIG. 8 is a functional block diagram schematically showing the configuration of the position-posture estimation device 101 according to the first embodiment. The position-posture estimation device 101 executes a process of calculating the position-posture based on a plurality of pieces of sensor data captured from different viewpoints. Here, the sensor data includes the camera image and the data detected by the distance sensor. As shown in FIG. 8, the position-posture estimation device 101 includes a database read-in unit 15, a frame selection unit 16, a relative position-posture acquisition unit 17, an absolute position-posture calculation unit 18 and an absolute position-posture integration unit 19.

The database read-in unit 15 executes a process of reading in a three-dimensional map stored in the database stored in the DB storage unit 14 (i.e., previously prepared three-dimensional map).

The frame selection unit 16 executes a process of selecting frames to be used for the calculation of the position-posture from frames of camera images captured from a plurality of different viewpoints. As the method for selecting the frames, there are a first selection method, a second selection method and a third selection method, for example.

In the first selection method, a relative movement amount is used. In the first selection method, whether a frame (key frame) should be selected or not is judged based on a condition that the change in the relative position obtained by the calculation of the relative position-posture is greater than or equal to a previously set threshold value of the change in the position and a condition that the change in the relative posture is greater than or equal to a previously set threshold value of the change in the posture. For example, a key frame satisfying at least one of the condition that the change in the relative position obtained by the calculation of the relative position-posture is greater than or equal to the previously set threshold value of the change in the position and the condition that the change in the relative posture is greater than or equal to the previously set threshold value of the change in the posture is selected.

In the second selection method, frames being different in terms of time are used. In the second selection method, frames from viewpoints adjoining in terms of time or frames (key frames) captured at a time interval greater than or equal to a threshold value in terms of time are selected.

In the third selection method, variance is used. In the third selection method, data to be used are selected based on the variance obtained at the time of generating the three-dimensional map. For example, a frame (key frame) from a viewpoint where the variance is less than a previously set threshold value of the variance is selected.

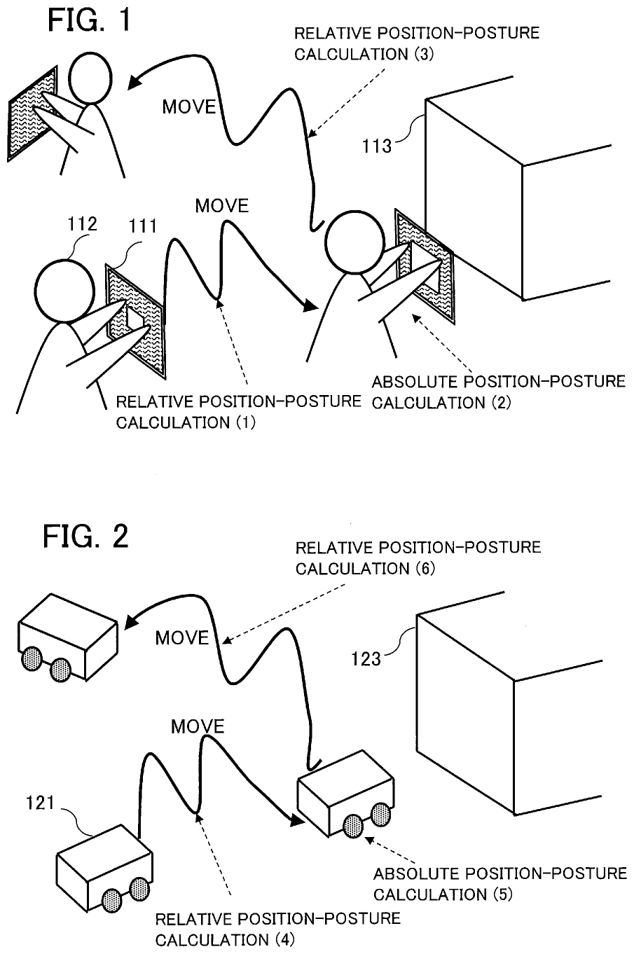

The relative position-posture acquisition unit 17 executes a process of acquiring the relative position-posture corresponding to the frame. The relative position-posture acquisition unit 17 acquires the result of calculating the relative position-posture by a method as one of the relative position-posture calculations in FIG. 1.

The absolute position-posture calculation unit 18 executes a process of calculating the absolute position-posture by using a plurality of selected frames. In this case, the position-posture is calculated by using perspective n points (PnP) or the like, for example.

The absolute position-posture integration unit 19 executes a process of calculating a final absolute position-posture by integrating a plurality of calculation results of the position-posture. As an integration method executed by the absolute position-posture integration unit 19, there are a first integration method, a second integration method and a third integration method, for example.

The first integration method uses the “winner takes all” system. Namely, in the first integration method, the position-posture estimated from the key frame having the smallest variance is employed as the final result.

The second integration method uses a weighted linear sum. Namely, in the second integration method, weighting is done based on the variance.

Values t̅ and R̅ respectively represent the finally obtained position and posture, and are respectively calculated according to expression (5) and expression (6).

Values t′ₖ and R′ₖ respectively represent the position (t′ₖ) in the k-th frame among the frames obtained by the frame selection unit 16 and the posture (R′ₖ) in the k-th frame.

Values wₜ_{ₖ} and w_{R}_{ₖ} respectively represent the weight (wₜₖ) for the position in the k-th frame and the weight (w_{Rk}) for the posture in the k-th frame, and are respectively calculated according to expression (7) and expression (8).

The weight wₜₖ for the position in the k-th frame and the weight w_{Rk} for the posture in the k-th frame are calculated by using the variance σₜₖ² of the position and the variance σ_{Rk}² of the posture as the variances of the key frame used for the calculation of the position-posture. It is also possible to calculate the weights by using standard deviations, namely, a standard deviation σₜₖ of the position and a standard deviation σ_{Rk} of the posture, which can be regarded as statistical indices equivalent to the variance σₜₖ² of the position and the variance σ_{Rk}² of the posture. When the standard deviations are used, the weight wₜₖ for the position in the k-th frame and the weight w_{Rk} for the posture in the k-th frame are respectively calculated according to expression (9) and expression (10).

$$\overline{t} = {\sum }_{k} {w}_{{t}_{k}} {t}_{k}^{′} \qquad ( 5 )$$

$$\overline{R} = {\sum }_{k} {w}_{{R}_{k}} {R}_{k}^{′} \qquad ( 6 )$$

$${w}_{{t}_{k}} = \frac{1 / {σ}_{{t}_{k}}^{2}}{{\sum }_{k} 1 / {σ}_{{t}_{k}}^{2}} \qquad ( 7 )$$

$${w}_{{R}_{k}} = \frac{1 / {σ}_{{R}_{k}}^{2}}{{\sum }_{k} 1 / {σ}_{{R}_{k}}^{2}} \qquad ( 8 )$$

$${w}_{{t}_{k}} = \frac{1 / {σ}_{{t}_{k}}}{{\sum }_{k} 1 / {σ}_{{t}_{k}}} \qquad ( 9 )$$

$${w}_{{R}_{k}} = \frac{1 / {σ}_{{R}_{k}}}{{\sum }_{k} 1 / {σ}_{{R}_{k}}} \qquad ( 10 )$$

In the expression (5) and the expression (6), the position-posture calculated by the absolute position-posture calculation unit 18 is not directly inputted to the position t′ₖ in the k-th frame and the posture R′ₖ in the k-th frame. The position-posture at the time of having moved to any intended frame from the position-posture calculated by the absolute position-posture calculation unit 18 is used. For example, when the frame selection unit 16 selects K frames (K: positive integer) and the integration is performed in adaptation to the K-th frame, the position t′ₖ in the k-th frame (k: positive integer) and the posture R′ₖ in the k-th frame are represented by expression (11). In the expression (11), the position tₖ in the k-th frame and the posture Rₖ in the k-th frame are the position-posture obtained by the absolute position-posture calculation unit 18.

Values R_{k→K} and t_{k→K} respectively represent a relative movement amount of the posture and a relative movement amount of the position from the k-th frame to the K-th frame, and are derived from the position-posture obtained by the relative position-posture acquisition unit 17. By using the expression (11), the absolute position-posture in the K-th frame is obtained.

$$( \begin{matrix}{R}_{k}^{′} & {t}_{k}^{′} \\ 0 & 1\end{matrix} ) = ( \begin{matrix}{R}_{k \to K} & {t}_{k \to K} \\ 0 & 1\end{matrix} ) ( \begin{matrix}{R}_{k} & {t}_{k} \\ 0 & 1\end{matrix} ) \qquad ( 11 )$$

The third integration method is a method of obtaining the absolute position-posture by means of nonlinear optimization. For example, as shown in expression (12), the position tₖ in the k-th frame and the posture Rₖ in the k-th frame are obtained so that a reprojection error is minimized.

A value L represents an intrinsic parameter (L) of the camera.

Values pₖᵢ and p′ₖᵢ respectively represent a three-dimensional position and an in-image point of a matched local feature.

A value Nₖ represents the number of matched local feature pairs in the k-th frame. A value wₖ represents a weight corresponding to the k-th frame, and either of the weights wₜₖ and w_{Rk} or a weight obtained by integrating the weights wₜₖ and w_{Rk} is used as the weight wₖ.

The absolute position-posture can be obtained by solving the expression (12) by a nonlinear optimization method such as the steepest descent method.

$$arg {min}_{{t}_{k} , {R}_{k} , {p}_{ki} ,} {\sum }_{k} {\sum }_{i}^{{N}_{k}} {w}_{k} {‖ {p}_{ki}^{′} - L ( \begin{matrix}1 & 0 & 0 & 0 \\ 0 & 1 & 0 & 0 \\ 0 & 0 & 1 & 0\end{matrix} ) ( \begin{matrix}{R}_{k} & {t}_{k} \\ 0 & 1\end{matrix} ) {p}_{ki} ‖}^{2} \qquad ( 12 )$$

### (1-2) Operation

### (1-2-1) Generation of Three-Dimensional Map

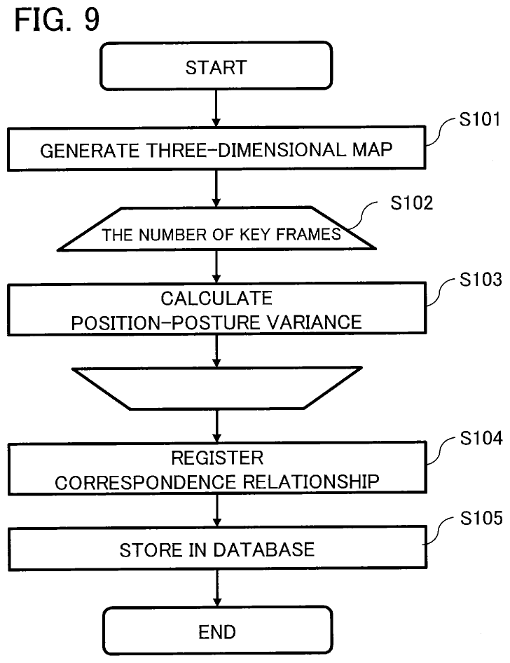

FIG. 9 is a flowchart showing an example of a process for generating the three-dimensional map executed by the three-dimensional map generation device according to the first embodiment. As shown in FIG. 9, the key frame detection unit 10 and the key frame position-posture calculation unit 11 execute the generation of the three-dimensional map (step S101). The generation of the three-dimensional map is executed by using SLAM while detecting the key frames, for example.

The position-posture variance calculation unit 12 calculates the variance of the position-posture in regard to each key frame (step S102) (step S103). Subsequently, the correspondence relationship registration unit 13 executes the registration of the correspondence relationship as shown in FIG. 7 (step S104). The correspondence relationship registration unit 13 executes a process of registering the three-dimensional map on the floor map and defining positional relationship with the overall map or another three-dimensional map, for example. The database storage unit 14 executes a process of storing the map generated by the above-described process in the three-dimensional map DB 102 (step S105).

### (1-2-2) Estimation of Position-Posture

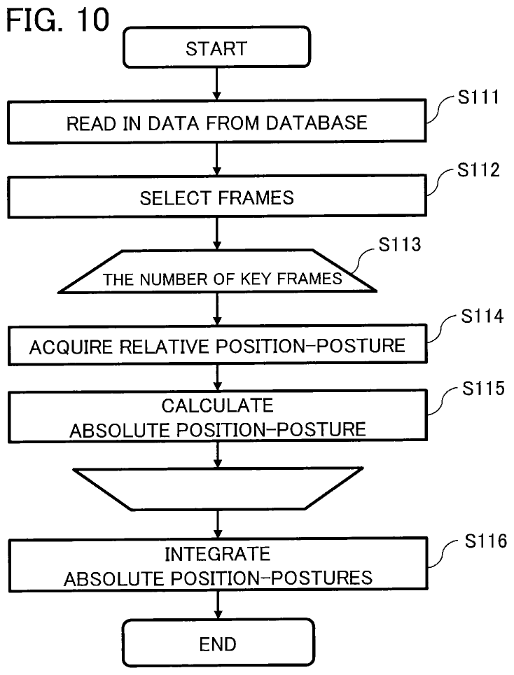

FIG. 10 is a flowchart showing an example of a process for estimating the position-posture executed by the position-posture estimation device 101 according to the first embodiment. The database read-in unit 15 reads in the three-dimensional map as data from the DB storage unit 14 (step S111). The frame selection unit 16 selects frames (step S112). The selected frames are frames to be processed based on predetermined rules.

The relative position-posture acquisition unit 17 executes a process of acquiring the relative position-posture corresponding to the frame in regard to each of the selected frames (step S113) (step S114). The absolute position-posture calculation unit 18 calculates the absolute position-posture based on the data of the selected frame (step S115). When the number of the selected frames reaches a previously set number, the process advances to an integration process.

The absolute position-posture integration unit 19 integrates the results of the absolute position-posture based on the variance (step S116).

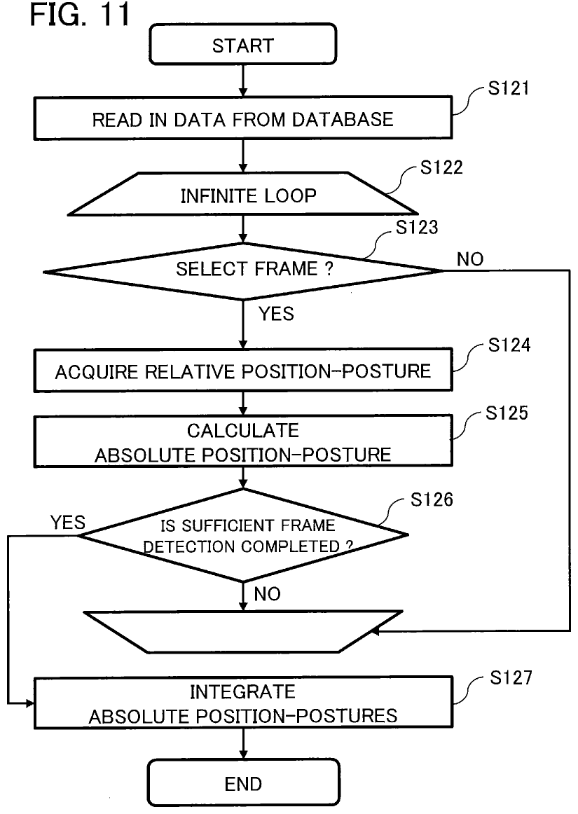

FIG. 11 is a flowchart showing another example of the process for estimating the position-posture executed by the position-posture estimation device according to the first embodiment. The database read-in unit 15 reads in the three-dimensional map as data from the database storage unit 14 (step S121). The frame selection unit 16 judges whether a frame should be selected or not (steps S122 and S123), and selects the frame when the frame should be selected. The selected frame is a frame to be processed based on predetermined rules.

The relative position-posture acquisition unit 17 executes a process of acquiring the relative position-posture corresponding to the selected frame (step S124). The absolute position-posture calculation unit 18 calculates the absolute position-posture in regard to each piece of selected data (step S125). The frame selection unit 16 judges whether sufficient frame detection is completed or not (step S126), and the integration process is executed when the sufficient frame detection is completed, or the process is returned to the step S122 when the sufficient frame detection is not completed yet. The “sufficient frame detection is completed” means that a previously set number of frames have been detected, a previously set number of absolute position-postures have been obtained, or the like, for example.

When the sufficient frame detection is completed, the absolute position-posture integration unit 19 integrates the results of the absolute position-posture based on the variance (step S127).

### (1-3) Effect

As described above, with the position-posture estimation device or the position-posture estimation method according to the first embodiment, the estimation of the position-posture is executed based on data of the position-posture obtained by using a plurality of images, and thus the accuracy of the estimation of the position-posture can be increased.

Further, the absolute position-posture with high accuracy can be calculated by executing the integration process without using the position-posture obtained from an image in which the variance of the position-posture calculation results is great, or by executing the integration process by reducing the weight regarding the position-posture obtained from an image in which the variance of the position-posture calculation results is great.

Furthermore, even when the subject in the image is short of features, high-accuracy estimation of its own position-posture in an absolute coordinate system can be realized and the amount of computation can be held down within a range in which real-time processing is possible.

### (2) SECOND EMBODIMENT

### (2-1) Configuration

(2-1-1)

It has been described in the first embodiment that there are the first estimation method using the direct matching and the second estimation method using the two-stage matching as methods for calculating the absolute position-posture by using camera images. Further, in the first embodiment, an example using the second estimation method is described. In a second embodiment, a description will be given of a method of integrating the position-postures obtained by the direct matching method using camera images and a position-posture integration method using a laser sensor such as a LiDAR (Light Detection and Ranging).

The hardware configuration of a position-posture estimation device and a position-posture estimation system according to the second embodiment is the same as that described in the first embodiment (FIG. 4 and FIG. 5). Thus, FIG. 4 and FIG. 5 are also referred to in the description of the second embodiment.

### (2-1-2) Three-Dimensional Map Generation Device

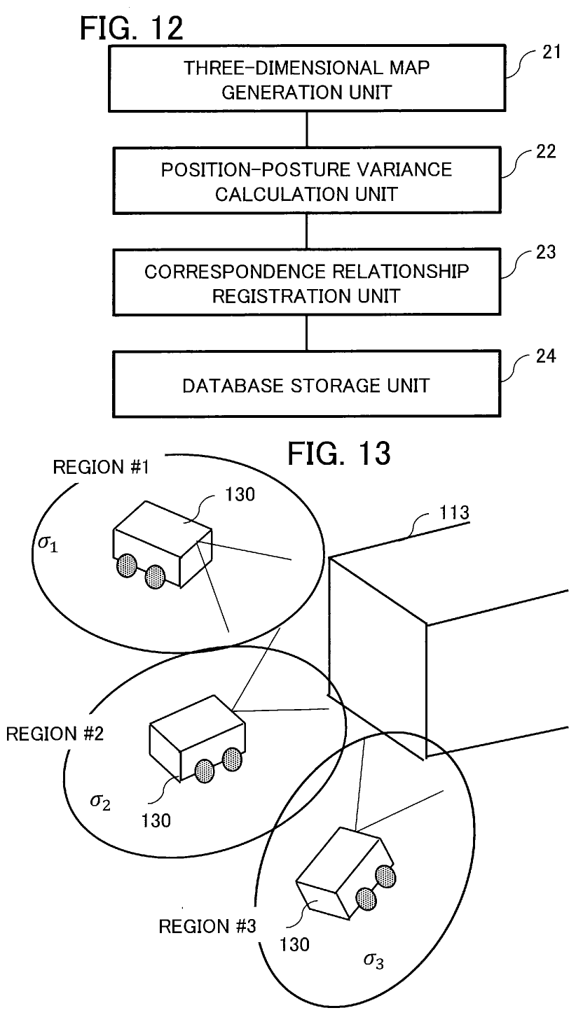

FIG. 12 is a functional block diagram schematically showing the configuration of a three-dimensional map generation device according to the second embodiment. The three-dimensional map generation device shown in FIG. 12 is a device capable of executing a three-dimensional map generation method according to the second embodiment. Incidentally, while the following description will be given of an example in which the three-dimensional map generation device is a part (i.e., map generation registration unit) of the position-posture estimation device, the three-dimensional map generation device can also be a device separate from the position-posture estimation device.

As shown in FIG. 12, the three-dimensional map generation device according to the second embodiment includes a three-dimensional map generation unit 21, a position-posture variance calculation unit 22, a correspondence relationship registration unit 23 and a database storage unit (DB storage unit) 24.

While three-dimensional data is managed in regard to each key frame in the first embodiment, a point set is managed as a three-dimensional map in the second embodiment. For example, when using an image, the three-dimensional map generation unit 21 generates local features obtained from the image and the positions of the local features as the three-dimensional map. When using a laser sensor such as a LiDAR, the observed point set (only the positions) is generated as the three-dimensional map. The three-dimensional map generation unit 21 in FIG. 12 executes a process of generating the above-described three-dimensional map data.

FIG. 13 is a diagram showing a method of calculating the variance used by the three-dimensional map generation device according to the second embodiment. FIG. 13 shows an example in which a robot 131 employing AGV estimates the position-posture by using the calculation of the relative position-posture and the calculation of the absolute position-posture when the robot 131 has moved. While the robot 131 calculates the variance, the calculation method of the variance differs from the calculation method in the first embodiment. Referring to FIG. 13, calculation of the variance σ₁, σ₂, σ₃ in regard to each region (e.g., region #1, #2, #3) surrounded by an ellipse will be explained below.

In concrete calculation of the variance, from the data observed when generating the three-dimensional map, a desired number of pieces of data are acquired (i.e., sampled) in regard to each region. The estimation of the absolute position-posture is executed by adding noise to the sampled data a plurality of times by different methods. The obtained variance is the variance of the position-posture in regard to each specified region. The method of adding the noise is the method of adding a random pattern in cases of an image, similarly to the first embodiment. Similarly, also in cases of a LiDAR, the noise is added by adding a random pattern to a local region. Here, the “random pattern” can include a pattern for removing data in the region.

The correspondence relationship registration unit 23 defines the relationship with the overall map or another three-dimensional map by the same method as the correspondence relationship registration unit 13 in the first embodiment.

The DB storage unit 24 stores the three-dimensional map and the variance in regard to each region in the database.

### (2-1-3) Position-Posture Estimation Device

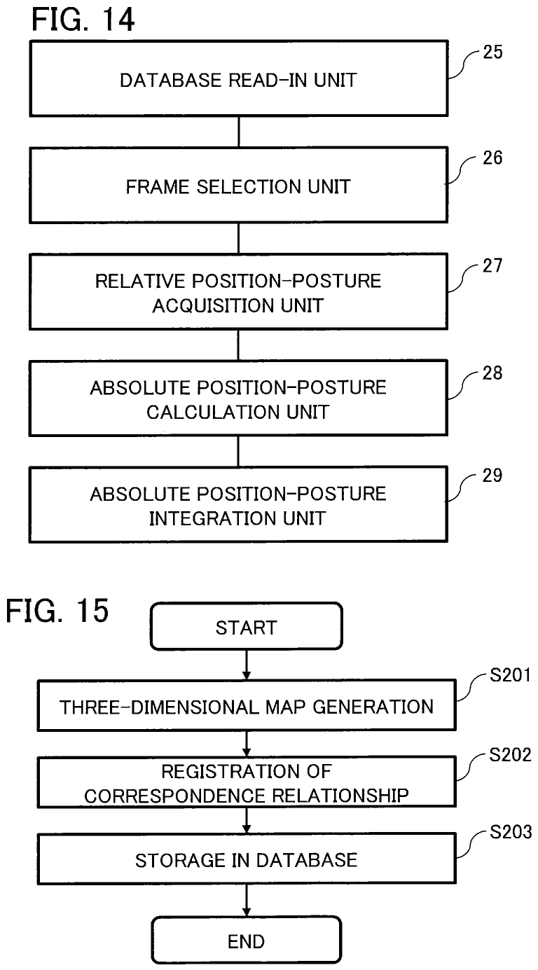

FIG. 14 is a functional block diagram schematically showing the configuration of the position-posture estimation device according to the second embodiment. The position-posture estimation device shown in FIG. 14 is a device capable of executing a position-posture estimation method according to the second embodiment. The position-posture estimation device includes a database read-in unit 25, a frame selection unit 26, a relative position-posture acquisition unit 27, an absolute position-posture calculation unit 28 and an absolute position-posture integration unit 29.

The database read-in unit 25 executes a process of reading in three-dimensional map data stored in the database.

The frame selection unit 26 selects frames by the same method as the frame selection unit 16 in the first embodiment, or selects frames from a plurality of previously divided regions so that there is no overlap. For example, a description will be given of an example in which an image is divided into three regions #1, #2 and #3 and the variance σ₁, σ₂, σ₃ is calculated and managed as shown in FIG. 13. The description will be given of an example in which the number of frames included in each of the regions #1, #2 and #3 is M in regard to the position-posture calculation results.

The relative position-posture acquisition unit 27 acquires the relative position-posture by the same method as the relative position-posture acquisition unit 17 in the first embodiment.

In cases of an image, the absolute position-posture calculation unit 28 calculates the absolute position-posture by using a method of calculating the position-posture by directly matching local features in the image (see Non-patent Reference 4, for example) or the like. When using data from a distance sensor employing a LiDAR, the position-posture is calculated by executing the matching between the three-dimensional map and shape information observed by the distance sensor.
Non-patent Reference 4: Torsten Sattler and two others, “Efficient & Effective Prioritized Matching for Large-Scale Image-Based Localization”, IEEE Transactions on Pattern Analysis and Machine Intelligence, Vol. 39, No. 9, September 2017

The absolute position-posture integration unit 29 integrates a plurality of position-postures by the same method as the absolute position-posture integration unit 19 in the first embodiment. The absolute position-posture integration unit 29 obtains the final position-posture based on the variance that has been set for each region.

### (2-2) Operation

### (2-2-1) Generation of Three-Dimensional Map

FIG. 15 is a flowchart showing an example of a process for generating the three-dimensional map executed by the three-dimensional map generation device according to the second embodiment. The three-dimensional map generation unit 21 and the position-posture variance calculation unit 22 generate the three-dimensional map, in which a map indicating the local features and the positions of the local features is generated in cases of using an image, or a map indicating the point set (only the positions) is generated in cases of using a LiDAR (step S201). The correspondence relationship registration unit 23 executes the registration of the correspondence relationship as a process corresponding to the three-dimensional map generation unit 21 (step S202). The database storage unit 24 executes a process of storing the correspondence relationship in the database (step S203).

### (2-2-2) Estimation of Position-Posture

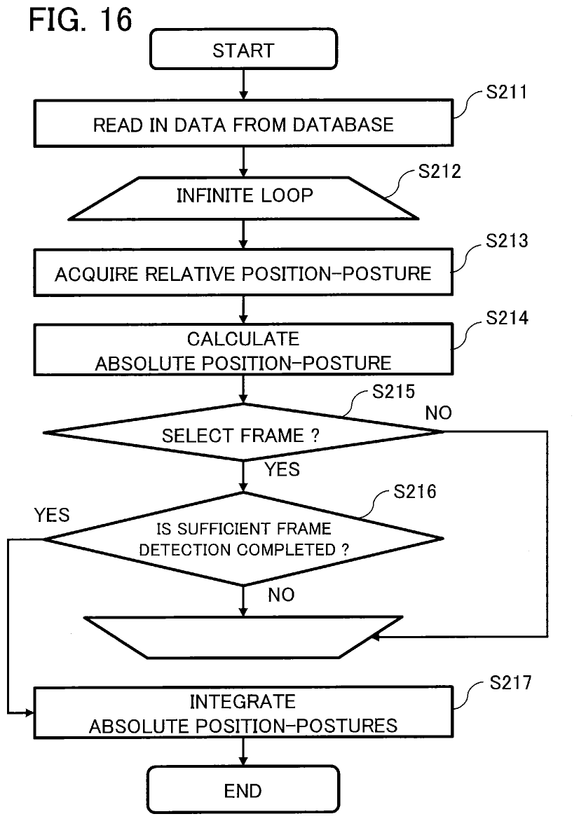

FIG. 16 is a flowchart showing an example of a process for estimating the position-posture executed by the position-posture estimation device according to the second embodiment. The database read-in unit 25 executes a process of reading in data from the database (step S211). The relative position-posture acquisition unit 27 acquires the relative position-posture and the absolute position-posture calculation unit 28 executes the calculation of the absolute position-posture (steps S212 to S214).

The frame selection unit judges whether selecting a frame is necessary or not (step S215), and when necessary, judges whether the sufficient frame detection is completed or not (step S216). When the sufficient frame detection is completed, the absolute position-posture integration unit 29 executes the integration of the absolute position-postures (step S217).

### (2-3) Effect

As described above, with the position-posture estimation device or the position-posture estimation method according to the second embodiment, in cases of using images and using the direct matching method or in cases of calculating the absolute position-posture by using a shape observed by a LiDAR, a plurality of frames are used, and thus the accuracy of the estimation of the position-posture can be increased.

### (3) THIRD EMBODIMENT

### (3-1) Configuration

(3-1-1)

There are cases where a terminal or robot used for AR manages the relative position-posture inside the instrument. In the case of AR, content is displayed in superimposition on an image by transforming the position of the content defined as the absolute position-posture into a coordinate system of the relative position-posture managed by the terminal. Similarly, also in the case of a robot, when a destination of the robot has been defined as an absolute position, the position needs to be transformed into a coordinate system of the relative position-posture managed by the robot.

In a third embodiment, a description will be given of a method of calculating an extrinsic parameter, as a matrix for the transformation from the coordinate system of the absolute position-posture to the coordinate system of the relative position-posture, with high accuracy by using a plurality of frames. In this description, a method of obtaining the extrinsic parameter with high accuracy by using a plurality of frames on the basis of the first embodiment will be described. The configuration of the third embodiment may be combined with the second embodiment or a fourth embodiment.

The hardware configuration of a position-posture estimation device and a position-posture estimation system according to the third embodiment is the same as that described in the first embodiment (FIG. 4 and FIG. 5). Thus, FIG. 4 and FIG. 5 are also referred to in the description of the third embodiment.

### (3-1-2) Three-Dimensional Map Generation Device

A three-dimensional map generation device according to the third embodiment is the same as that in the first embodiment.

### (3-1-3) Position-Posture Estimation Device

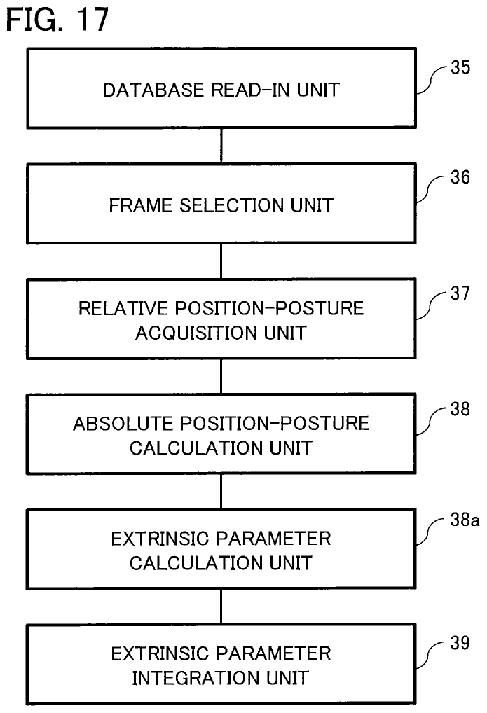

FIG. 17 is a functional block diagram schematically showing the configuration of the position-posture estimation device according to the third embodiment. The position-posture estimation device shown in FIG. 17 is a device capable of executing a position-posture estimation method according to the third embodiment. The position-posture estimation device includes a database read-in unit 35, a frame selection unit 36, a relative position-posture acquisition unit 37, an absolute position-posture calculation unit 38, an extrinsic parameter calculation unit 38a, and an extrinsic parameter integration unit 39 as an absolute position-posture integration unit.

The third embodiment differs from the first embodiment in that the position-posture estimation device includes the extrinsic parameter calculation unit 38a that calculates the extrinsic parameter for each of the selected frames and the extrinsic parameter integration unit 39 that integrates a plurality of extrinsic parameters. In regard to the processing by the other components, the process in the third embodiment is the same as the process in the first embodiment.

The extrinsic parameter calculation unit 38a calculates the extrinsic parameter on the assumption that the calculation of the relative position-posture and the calculation of the absolute position-posture have been executed based on the same frame. In this case, the extrinsic parameter is calculated according to expression (13).

Values tkabs and Rkabs represent the absolute position and the absolute posture obtained by using the k-th frame.

Values tkrel and Rkrel represent the relative position and the relative posture in the k-th frame.

Values t′ₖ and R′ₖ represent the extrinsic parameter (t′ₖ and R′ₖ) in the k-th frame, and are calculated according to the expression (13).

$$( \begin{matrix}{R}_{k}^{′} & {t}_{k}^{′} \\ 0 & 1\end{matrix} ) = ( \begin{matrix}{R}_{k}^{rel} & {t}_{k}^{rel} \\ 0 & 1\end{matrix} ) {( \begin{matrix}{R}_{k}^{abs} & {t}_{k}^{abs} \\ 0 & 1\end{matrix} )}^{- 1} \qquad ( 13 )$$

The processing by the extrinsic parameter integration unit 39 is substantially the same as that by the absolute position-posture integration unit 19 (FIG. 8) in the first embodiment. Thus, the extrinsic parameter integration unit 39 is referred to also as the absolute position-posture integration unit. While a plurality of absolute position-postures are integrated in the first embodiment, the extrinsic parameters are integrated in the third embodiment Specifically, the extrinsic parameters are integrated by using t′ₖ and R′ₖ obtained according to the expression (13). For example, in integration in terms of a weighted linear sum, the integration is performed by substituting t′ₖ and R′ₖ in the expression (13) into the expression (5) and the expression (6).

### (3-2) Operation

### (3-2-1) Generation of Three-Dimensional Map

The flow of the three-dimensional map generation process is the same as that in the first embodiment, and thus repeated description thereof is omitted here. The flow of a process of the method of integrating the extrinsic parameters will be described below.

### (3-2-2) Estimation of Position-Posture

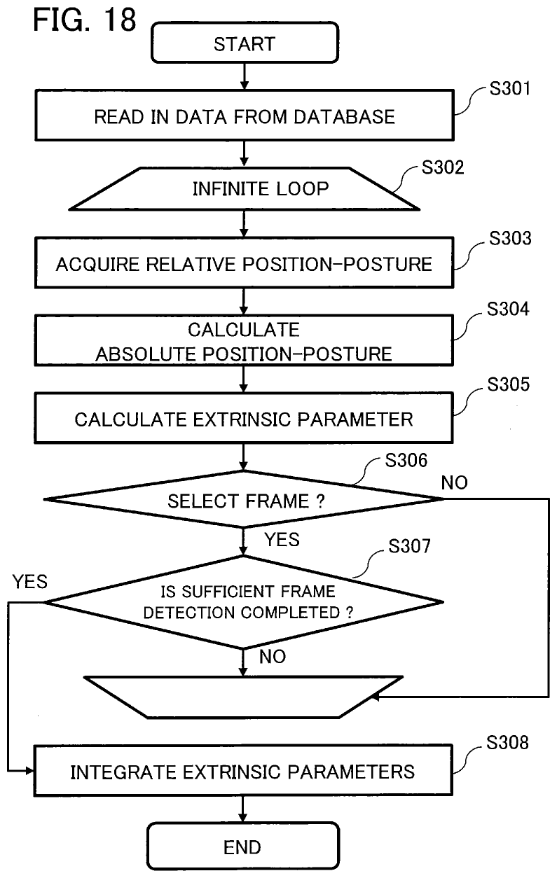

FIG. 18 is a flowchart showing an example of a process for estimating the position-posture executed by the position-posture estimation device according to the third embodiment. The database read-in unit 35 executes a process of reading in data from the database (step S301). The relative position-posture acquisition unit 37 acquires the relative position-posture (steps S302 and S303). The absolute position-posture calculation unit 38 executes the calculation of the absolute position-posture (step S304). The extrinsic parameter calculation unit 38a calculates the extrinsic parameter (step S305).

The frame selection unit 36 judges whether selecting a frame is necessary or not (step S306), and when necessary, judges whether the sufficient frame detection is completed or not (step S307). When the sufficient frame detection is completed, the extrinsic parameter integration unit 39 executes the integration of the absolute position-postures (step S308).

### (3-3) Effect

As described above, with the position-posture estimation device or the position-posture estimation method according to the third embodiment, the transformation matrix from the coordinate system of the absolute position-posture to the coordinate system of the relative position-posture can be obtained with high accuracy, and thus the content can be displayed with high accuracy on the terminal employed for AR. Further, when this embodiment is employed for a robot, the destination of the robot can be obtained with high accuracy.

### (4) FOURTH EMBODIMENT

### (4-1) Configuration

(4-1-1)

In a fourth embodiment, a description will be given of an embodiment obtained by adding an error process using a plurality of frames to the position-posture estimation method in the first embodiment. In the calculation of the absolute position-posture using images, when the subject has only few characteristic patterns, the outputted values of the position-posture can include great errors. To exclude such results, a position-posture estimation device according to the fourth embodiment executes the error process.

The hardware configuration of the position-posture estimation device and a position-posture estimation system according to the fourth embodiment is basically the same as that described in the first embodiment (FIG. 4 and FIG. 5). Thus, FIG. 4 and FIG. 5 are also referred to in the description of the fourth embodiment.

### (4-1-2) Three-Dimensional Map Generation Device

The configuration of a three-dimensional map generation device according to the fourth embodiment is the same as that in the first embodiment.

### (4-1-3) Position-Posture Estimation Device

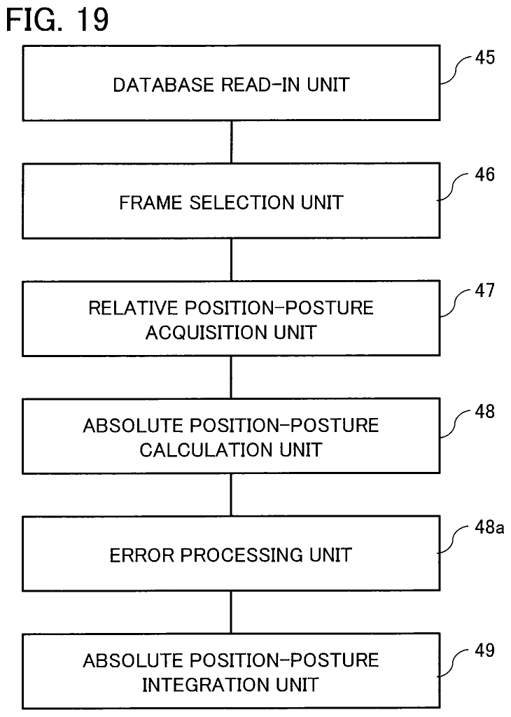

FIG. 19 is a functional block diagram schematically showing the configuration of the position-posture estimation device according to the fourth embodiment. The position-posture estimation device shown in FIG. 19 is a device capable of executing a position-posture estimation method according to the fourth embodiment. The position-posture estimation device according to the fourth embodiment differs from that in the first embodiment in further including an error processing unit 48a.

As shown in FIG. 19, the position-posture estimation device according to the fourth embodiment includes a database read-in unit 45, a frame selection unit 46, a relative position-posture acquisition unit 47, an absolute position-posture calculation unit 48, the error processing unit 48a, and an absolute position-posture integration unit 49. The database read-in unit 45, the frame selection unit 46, the relative position-posture acquisition unit 47, the absolute position-posture calculation unit 48 and the absolute position-posture integration unit 49 are the same as the database read-in unit 15, the frame selection unit 16, the relative position-posture acquisition unit 17, the absolute position-posture calculation unit 18 and the absolute position-posture integration unit 19 shown in FIG. 8.

The error processing unit 48a executes the error process. In the error process, by comparing a plurality of absolute position-posture calculation results obtained in a plurality of frames, an absolute position-posture calculation result whose error is greater than a predetermined threshold value is excluded from the integration process. An example of the error process is shown in expression (14) and expression (15). A j-th frame (j: positive integer less than or equal to K) is a frame satisfying j≠k among the K frames selected by the frame selection unit 46. The plurality of absolute position-posture calculation results obtained in the plurality of frames should indicate the same position-posture. Therefore, the error processing unit 48a compares an absolute position-posture calculation result obtained in a certain frame with an absolute position-posture calculation result obtained in a different frame. When a calculated difference in the position is greater than a predetermined threshold value th_t (i.e., when the expression (14) is satisfied) and when a calculated difference in the posture is greater than a predetermined threshold value th_r (i.e., when the expression (15) is satisfied), the error processing unit 48a excludes the calculation result in that frame.

$$‖ {t}_{k}^{′} - {t}_{j}^{′} ‖ > th\_t \qquad ( 14 )$$

$$‖ \frac{tr ( {( {R}_{k}^{′} )}^{- 1} {R}_{j}^{′} ) - 1}{2} ‖ > th\_r \qquad ( 15 )$$

### (4-2) Operation

### (4-2-1) Generation of Three-Dimensional Map

The operation of the three-dimensional map generation device according to the fourth embodiment is the same as that in the first embodiment.

### (4-2-2) Estimation of Position-Posture

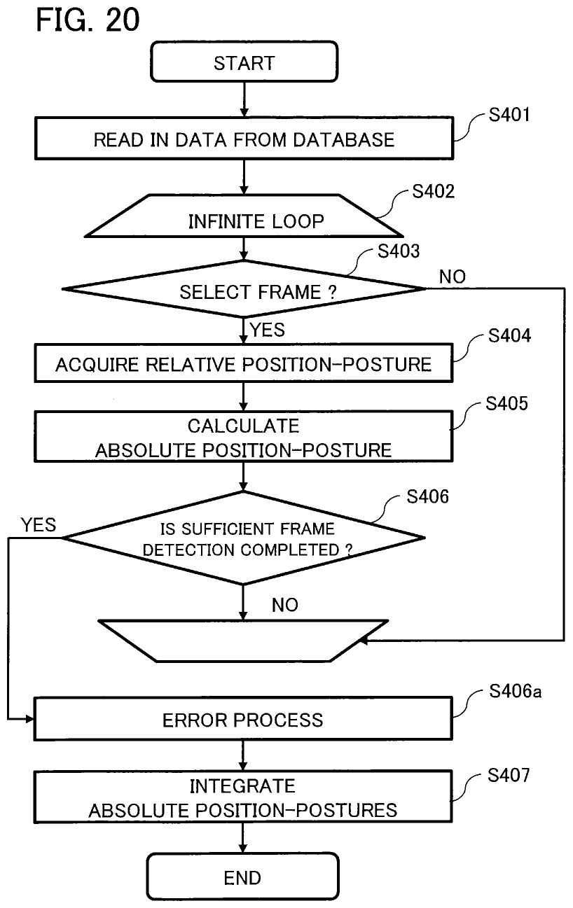

FIG. 20 is a flowchart showing another example of the process for estimating the position-posture executed by the position-posture estimation device according to the fourth embodiment. The operation of the position-posture estimation device shown in FIG. 20 differs from the operation of the position-posture estimation device according to the first embodiment shown in FIG. 11 in that the error process (step S406a) is added. Processing in steps S401 to S406 and S407 shown in FIG. 20 is the same as the processing in the steps S101 to S107 shown in FIG. 11.

### (4-3) Effect

As described above, with the position-posture estimation device or the position-posture estimation method according to the fourth embodiment, the error process is executed, and thus absolute position-posture estimation with higher environmental resistance can be realized (namely, higher estimation accuracy of the absolute position-posture against various types of environments can be realized) compared to the first embodiment.

### (5) DESCRIPTION OF REFERENCE CHARACTERS

10: key frame detection unit, 11: key frame position-posture calculation unit, 12, 22: position-posture variance calculation unit, 13, 23: correspondence relationship registration unit, 14, 24: DB storage unit, 15, 25, 35, 45: database read-in unit, 16, 26, 36, 46: frame selection unit, 17, 27, 37, 47: relative position-posture acquisition unit, 18, 28, 38, 48: absolute position-posture calculation unit, 19, 29, 49: absolute position-posture integration unit, 21: three-dimensional map generation unit, 38a: extrinsic parameter calculation unit, 39: extrinsic parameter integration unit (absolute position-posture integration unit), 48a: error processing unit, 100: position-posture estimation system, 101: position-posture estimation device, 102: three-dimensional map DB, 103: distance sensor, 104: camera, 105: display, 106: gyro sensor, 107: acceleration sensor, 108: geomagnetism sensor.

What is claimed is:

1. A position-posture estimation device comprising:
processing circuitry
to read in data of a three-dimensional map from a database;
to execute a process of selecting a frame to be used for calculation of a position-posture from a plurality of image frames captured from different viewpoints;
to execute a process of acquiring a plurality of relative position-postures regarding a plurality of frames selected by the frame selection unit;
to execute a process of acquiring a plurality of absolute position-postures regarding the plurality of selected frames; and
to acquire a final absolute position-posture by integrating the acquired relative position-postures and the acquired absolute position-postures.

2. The position-posture estimation device according to claim 1, wherein the processing circuitry
detects a key frame in a camera image captured by a camera;
calculates a position and posture of the camera that captured the key frame;
executes a process of calculating variance of the position-posture in regard to each key frame;
executes a process of generating registration data by positioning the three-dimensional map in register with a floor map; and
executes a process of storing the registration data in the database.

3. The position-posture estimation device according to claim 2, wherein the processing circuitry integrates the plurality of absolute position-postures based on the variance of the position-posture calculated in regard to each key frame.

4. The position-posture estimation device according to claim 3, wherein the processing circuitry employs the position-posture estimated in a key frame whose variance is smallest among the key frames as the final absolute position-posture.

5. The position-posture estimation device according to claim 3, wherein the processing circuitry calculates a weight based on the variance in regard to each key frame and integrates the plurality of absolute position-postures based on a weighted linear sum using the weights.

6. The position-posture estimation device according to claim 2, wherein the processing circuitry integrates the plurality of absolute position-postures by using nonlinear optimization.

7. The position-posture estimation device according to claim 1, wherein the processing circuitry
generates a three-dimensional map in regard to each local region from a camera image captured by a camera or distance information measured by a distance sensor;
executes a process of calculating variance of the position-posture in regard to each region from the camera image or the distance information;
executes a process of generating registration data by positioning the three-dimensional map in register with a floor map; and
executes a process of storing the registration data in the database.

8. The position-posture estimation device according to claim 7, wherein the processing circuitry integrates the plurality of absolute position-postures based on the variance of the position-posture in regard to each region calculated in regard to each region.

9. The position-posture estimation device according to claim 2, wherein the processing circuitry
calculates an extrinsic parameter in regard to each key frame, and
integrates the plurality of absolute position-postures by integrating a plurality of calculated extrinsic parameters.

10. The position-posture estimation device according to claim 9, wherein the processing circuitry integrates the plurality of extrinsic parameters based on the variance of the position-posture calculated in regard to each key frame.

11. The position-posture estimation device according to claim 2, wherein the processing circuitry excludes a calculation result of the absolute position-posture obtained in regard to a key frame from use in the integration process when an error of the absolute position-posture calculated in regard to the key frame is greater than a predetermined threshold value.

12. A position-posture estimation method executed by a position-posture estimation device, the method comprising:
reading in data of a three-dimensional map from a position database;
executing a process of selecting a frame to be used for calculation of a position-posture from a plurality of image frames captured from different viewpoints;
executing a process of acquiring a plurality of relative position-postures regarding a plurality of selected frames;
executing a process of acquiring a plurality of absolute position-postures regarding the plurality of selected frames; and
acquiring a final absolute position-posture by integrating the acquired relative position-postures and the acquired absolute position-postures.

13. A non-transitory computer-readable storage medium for storing a program that causes a computer to execute:
reading in data of a three-dimensional map from a position database;
executing a process of selecting a frame to be used for calculation of a position-posture from a plurality of image frames captured from different viewpoints;
executing a process of acquiring a plurality of relative position-postures regarding a plurality of selected frames;
executing a process of acquiring a plurality of absolute position-postures regarding the plurality of selected frames; and
acquiring a final absolute position-posture by integrating the acquired relative position-postures and the acquired absolute position-postures.
